(19) United States
(12) Patent Application Publication
(10) Pub. No.: US 2008/0186735 A1
(43) Pub. Date: Aug. 7, 2008

(54) High Optical Efficiency Illumination Device for Use in Image Reading

(76) Inventor: WENG-LYANG WANG, Saratoga, CA (US)

Correspondence Address: CHEIN-HWA S. TSAO, 6684 MT PAKRON DRIVE, SAN JOSE, CA, 95120, US

(21) Appl. No.: 11/671,595

(22) Filed: Feb. 6, 2007

(51) Int. Cl. F21V 7/04

(52) U.S. Cl. 362/613; 362/608

(57) ABSTRACT

A high efficiency illumination device has a light guide with a light entrance for converting entering lights into lights exiting through light exit surfaces. Numerous light emitting elements are arranged near the light entrance. A mounting mechanism is interposed between the light emitting elements and the light entrance for affixing them to each other. For each light emitting element, the mounting mechanism also includes an integrated lens for collecting and collimating lights emanated from the light emitting element into the light entrance. In one embodiment, the illumination device further includes an anti-reflection layer placed between the integrated lens and the light entrance to minimize light loss due to Fresnel reflection at the interface between them. The anti-reflection layer can be made of a transparent and non-evaporating liquid material to form an intimately conforming, long lasting air-free bridge between the integrated lens and the light entrance.

### BACKGROUND OF THE INVENTION

1. Field of the Invention

The present invention relates to an illumination device. More particularly, the present invention relates to a linear illumination device having a light guide to provide uniform illumination to a target as used in an image reading apparatus such as copying apparatus, facsimile apparatus, scanner and electronic blackboard.

2. Related Background Art

A variety of image reading apparatus having various types of illumination devices have been proposed for image input and conversion of an original document into image signals. For example, U.S. Pat. Nos. 5,808,295 and 5,499,112 disclosed a reading apparatus of an information processing system such as a scanner as shown in FIG. 1A and FIG. 1B, in which Light Emitting Diodes (LEDs) are used to light up the front end of a long, thin light guide that creates a narrow strip of light on a paper target scanned by a linear imaging system.

To facilitate explaining the background leading to the present invention, a typical traditional illumination device 2 is illustrated here in FIG. 1A. The traditional illumination device 2 has a number of light emitting elements 40a, 40b and 40c embedded in a mounting block 48. For full color illumination, the primary wavelengths of emission of the light emitting elements 40a, 40b and 40c correspond respectively to RED, GREEN and BLUE. A number of electrical terminals 41 are, internal to the mounting block 48, electrically connected to the light emitting elements 40a, 40b and 40c for energizing them thus emitting numerous light beams 44a, 44b, 44c and 44d from the light emitting element 40a. To avoid excessive obscuring details, the numerous corresponding light beams emitted from light emitting elements 40b and 40c are omitted here. Intimately mated with the mounting block 48 is a longitudinal light guide 20 along the Z-axis. In this case, the mating is accomplished with a mounting socket 52 and a mounting pin 50 respectively located on the opposing faces of the mounting block 48 and the light guide 20. For clarity of illustrating the mating, the mounting block 48 and the light guide 20 are purposely drawing as separated. The light guide 20 has a light entrance 22 located at a first end 25a of a longitudinal axis 24 for accepting the numerous emitted light beams 44a, 44b, 44c and 44d. The light guide 20 also has numerous light reflective surfaces 26 and opposing light exit surfaces 28 located either at a second end 25b of the light guide 20 or along the longitudinal axis 24 for converting lights entering the light entrance 22 into illumination light beams 46 exiting through the light exit surfaces 28. A cross section of the traditional illumination device 2 along section A-A is shown in FIG. 1B. Notice that, while the majority of the numerous emitted light beams 44a, 44b and 44c do enter the light guide 20 and get converted into useful illumination light beams 46, a fraction of light beams 44e and 44f nevertheless impinge upon the light entrance 22 at sufficiently oblique angles of incident thus end up escaping the light guide 20 even with the help of light refraction at the light entrance 22. Additionally, while not easily illustrated here, for those skilled in the art there is yet another loss of light due to Fresnel back reflection at the light entrance 22 as long as there is a difference in index of refraction across the light entrance 22 interface. These mechanisms result in a corresponding undesirable loss of optical efficiency of the traditional illumination device 2 defined, for each light emitting element such as the light emitting element 40a, as the amount of light power exiting the light exit surfaces 28 divided by the amount of light power emanated from the light emitting element. For those skilled in the art, by now it should become clear that similar mechanisms also take place in section B-B and cause a corresponding undesirable loss of optical efficiency as well.

Accordingly, it is an object of the present invention to provide an improved illumination device with a higher optical efficiency.

### SUMMARY OF THE INVENTION

A high optical efficiency illumination device is proposed. The high optical efficiency illumination device has:
a) A light guide having a longitudinal axis, a transverse axis and a light entrance located at a first end of the longitudinal axis. The light guide also includes light reflective surfaces and opposing light exit surfaces located along the longitudinal axis for converting lights entering the light entrance into lights exiting through the light exit surfaces.
b) A number of light emitting elements of various light emission wavelength ranges and arranged near the first end of the longitudinal axis for emitting light beams into the light guide through the light entrance.
c) A mounting mechanism, interposed between the light emitting elements and the light entrance, for locating and affixing the light emitting elements to the light entrance.
d) For each light emitting element, the mounting mechanism also includes a corresponding integrated lens structure for collecting and collimating the light emission emanated from the light emitting element into the light entrance.

In a particular embodiment, at least two of the light emitting elements are of the same pre-determined light emission wavelength range and are simultaneously energized so as to increase the amount of light power exiting the light exit surfaces at the pre-determined light emission wavelength range for applications requiring even higher light power.

In a particular embodiment, the corresponding integrated lens structure is sized and shaped to further collect and collimate the light emission emanated from each light emitting element into a direction substantially parallel to the longitudinal axis.

In another embodiment, the integrated lens structure is placed in intimate contact with the light entrance and the index of refraction of the integrated lens structure is selected to be essentially the same as that of the light entrance to further minimize an otherwise present light power loss due to Fresnel reflection at the interface between the integrated lens structure and the light entrance.

In another embodiment, the illumination device further includes an anti-reflection layer placed between the integrated lens structure and the light entrance to minimize an otherwise present light power loss due to Fresnel reflection at the interface between the integrated lens structure and the light entrance.

In another embodiment, the anti-reflection layer is made of a transparent and non-evaporating liquid material to form an intimately conforming, air-free bridge between the integrated lens structure and the light entrance. For index matching, the index of refraction of the anti-reflection layer, n_{AR}, is selected to be essentially:

n_{AR}=SQRT(n_{L}×n_{E})

where n_{L} and n_{E} are, respectively, the index of refraction of the integrated lens structure and the light entrance.

In another embodiment, the integrated lens structure is placed in intimate contact with the light emitting element and the index of refraction of the integrated lens structure is selected to be essentially the same as that of the light emitting element to further minimize an otherwise present light power loss due to Fresnel reflection at the interface between the light emitting element and the integrated lens structure.

In another embodiment, the anti-reflection layer is made of a transparent and non-evaporating liquid material to form an intimately conforming, air-free bridge between the light emitting element and the integrated lens structure.

In another embodiment, the index of refraction of the anti-reflection layer, n_{AR}, is selected to be essentially:

n_{AR}=SQRT(n_{LED}×n_{L})

where n_{LED} and n_{L} are, respectively, the index of refraction of the light emitting element and the integrated lens structure.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative:

FIG. 2A and FIG. 2B are perspective and sectional views of an embodiment of the present invention;

FIG. 3A, FIG. 3B and FIG. 3C illustrate numerous ways for locating and affixing the light emitting elements to the light entrance of the light guide;

FIG. 4A illustrates the placement of an integrated lens structure in intimate contact with the light entrance to minimize an otherwise present light power loss due to Fresnel reflection at the interface between the integrated lens structure and the light entrance;

FIG. 4B illustrates the placement of an anti-reflection layer between the integrated lens structure and the light entrance to minimize an otherwise present light power loss due to Fresnel reflection at the interface between the integrated lens structure and the light entrance; and

FIG. 4C illustrates the placement of a liquid anti-reflection layer between a light emitting element and the integrated lens structure to minimize an otherwise present light power loss due to Fresnel reflection at the interface between the light emitting element and the integrated lens structure.

### DETAILED DESCRIPTION OF THE PREFERRED EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

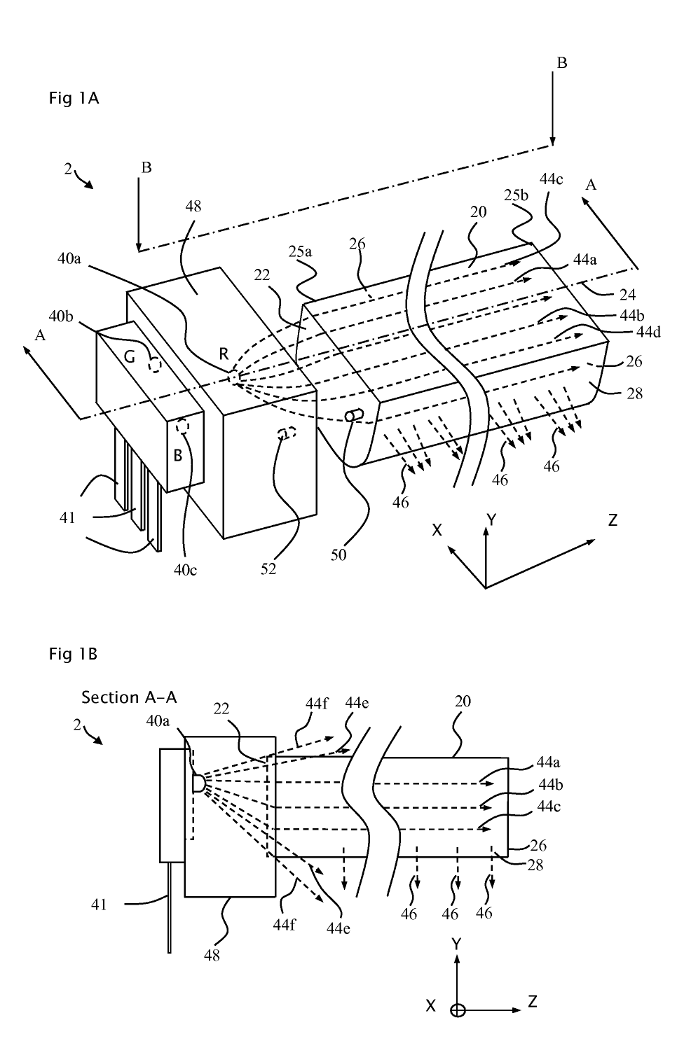

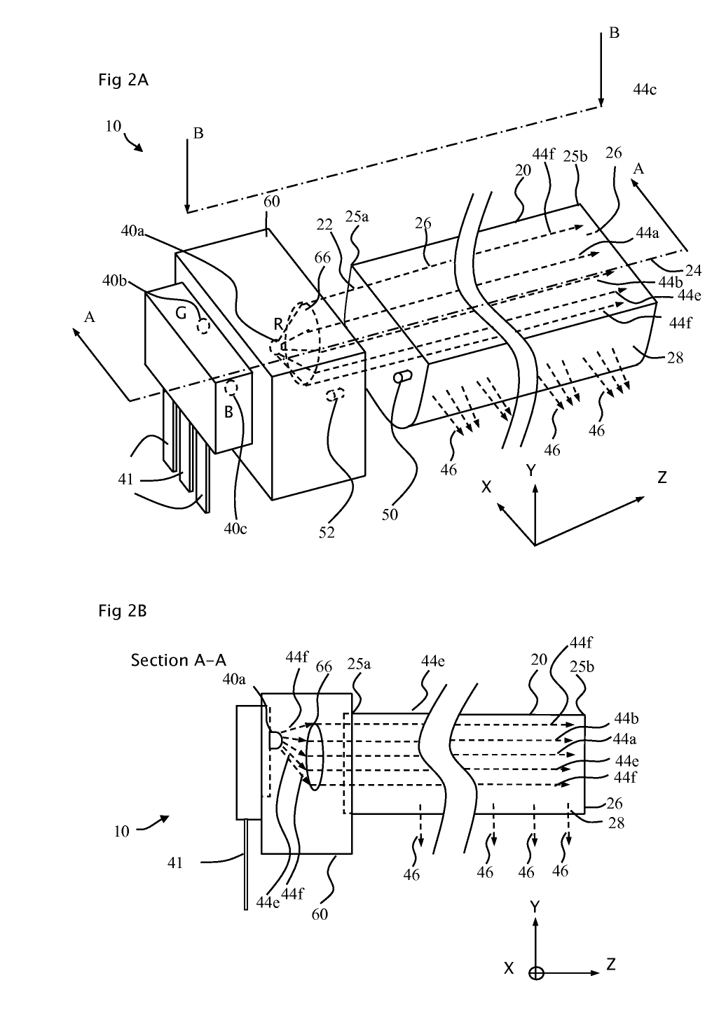

FIG. 2A and FIG. 2B are perspective and sectional views of an embodiment of the present invention high efficiency illumination device 10. Like before, the high efficiency illumination device 10 has a light guide 20 with a longitudinal axis 24 (along the Z-direction), a transverse axis (in the X-Y plane) and a light entrance 22 located at a first end 25a of the longitudinal axis 24. The light guide 20 also has numerous light reflective surfaces 26 and opposing light exit surfaces 28 located either at a second end 25b of the light guide 20 or along the longitudinal axis 24 for converting lights entering the light entrance 22 into illumination light beams 46 exiting through the light exit surfaces 28. However, intimately mated with the light guide 20 is a light-collimating mounting block 60. While the light-collimating mounting block 60 still embeds the light emitting elements 40a, 40b and 40c of various light emission wavelength ranges, the light-collimating mounting block 60 now includes an additional integrated lens structure 66. Location wise, the light-collimating mounting block 60 is interposed between the light emitting elements 40a, 40b and 40c and the light entrance 22. Like in FIG. 1A and FIG. 1B, to avoid excessive obscuring details, the numerous corresponding light beams emitted from light emitting elements 40b and 40c are omitted here. Similarly, the mating is accomplished with a mounting socket 52 and a mounting pin 50 respectively located on the opposing faces of the light-collimating mounting block 60 and the light guide 20. Again for clarity of illustrating the mating, the light-collimating mounting block 60 and the light guide 20 are purposely drawing as separated. As shown, for the light emitting element 40a the light-collimating mounting block 60 now includes a corresponding integrated lens structure 66 for collecting and collimating the light emission emanated from the light emitting element 40a into the light entrance 22. For those skilled in the art, the integrated lens structure 66 should be understood to include a lens body having a number of light-bending surfaces based upon light refraction for collimating light emissions plus necessary mechanical mounting features for accurately affixing the lens body to the light-collimating mounting block 60. Owing to the light collecting and collimating power of the integrated lens structure 66, in addition to the fact that the numerous paraxially emitted light beams 44a and 44b (approximately parallel to the longitudinal axis 24) continue to enter the light guide 20 and get converted into useful illumination light beams 46, most of the other light beams 44e and 44f with oblique angles of incidence onto the integrated lens structure 66 now get redirected and focused into the light guide 20 through the light entrance 22 as well. Accordingly, this embodiment of the present invention works to maximize the optical efficiency of the high efficiency illumination device 10. While, to those skilled in the art, for each of the other light emitting elements 40b and 40c the light-collimating mounting block 60 can also include a corresponding integrated lens structure for collecting and collimating the light emission emanated from 40b and 40c, these additional integrated lens structures and related light beams are not shown here to avoid unnecessary obscuring details. Another improvement is that, the integrated lens structure 66 can be sized and shaped to further collect and collimate the light emission emanated from the light emitting element 40a into a direction substantially parallel to the longitudinal axis 24 (Z-axis) for easier containment within the light guide 20 thus simplifying its design.

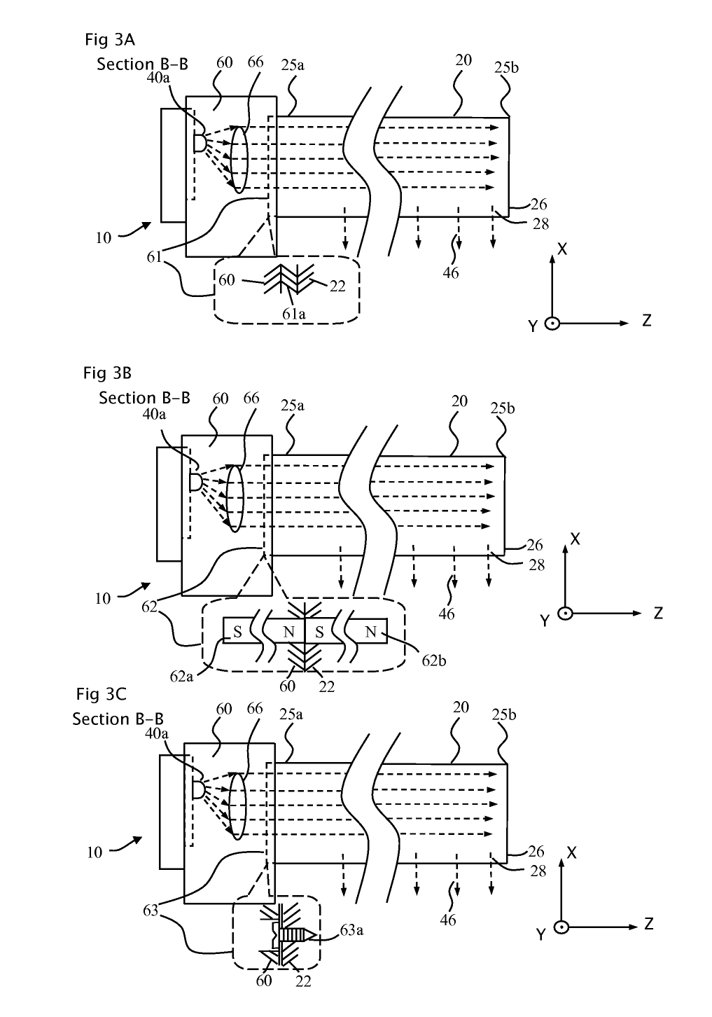

FIG. 3A, FIG. 3B and FIG. 3C illustrate numerous ways for locating and affixing the light emitting element 40a to the light entrance 22 of the light guide 20. In FIG. 3A the light-collimating mounting block 60 is butted against the light entrance 22 through a glue mounting interface 61. An enlarged glue mounting interface 61 showing a glue film 61a bonding the light-collimating mounting block 60 to the light entrance 22 is further illustrated in an inset. In FIG. 3B the light-collimating mounting block 60 is butted against the light entrance 22 through a magnetic mounting interface 62. An inset illustrates an enlarged magnetic mounting interface 62 showing a pair of magnets 62a and 62b respectively embedded within the light-collimating mounting block 60 and the light entrance 22, oriented to stay together via magnetic attraction. In FIG. 3C the light-collimating mounting block 60 is fastened against the light entrance 22 through a screw mounting interface 63. An inset illustrates an enlarged screw mounting interface 63 showing a mounting screw 63a tying the light-collimating mounting block 60 and the light entrance 22 together.

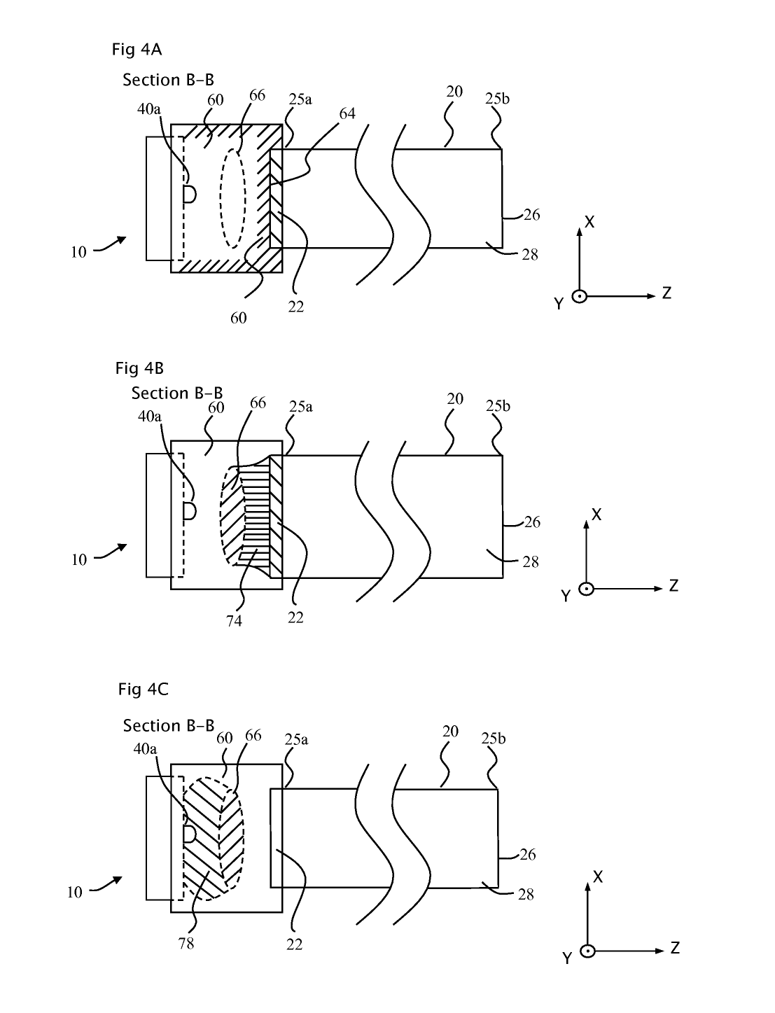

FIG. 4A illustrates the placement of an integrated lens structure 66 in intimate contact with the light entrance 22 to minimize an otherwise present light power loss due to Fresnel reflection at the interface 64 between the integrated lens structure 66 and the light entrance 22. To effect the intimate contact interface 64, both the contacting surface at the side of integrated lens structure 66 and at the side of light entrance 22 should be of optical quality with a surface roughness less than the wavelength of the light emission. To further minimize the Fresnel reflection at the intimate contact interface 64, the index of refraction of the integrated lens structure 66 should be selected to be essentially the same as that of the light entrance 22. While not shown here, by the same token the integrated lens structure 66 can instead be placed in intimate contact with the light emitting element 40a and the index of refraction of the integrated lens structure 66 can instead be selected to be essentially the same as that of the light emitting element 40a to minimize a corresponding light power loss due to Fresnel reflection at the interface between the light emitting element 40a and the integrated lens structure 66.

As an alternative embodiment, FIG. 4B illustrates the placement of an anti-reflection layer 74 between the integrated lens structure 66 and the light entrance 22 to minimize an otherwise present light power loss due to Fresnel reflection at the interface between the integrated lens structure 66 and the light entrance 22. Furthermore, the anti-reflection layer 74 can be made of a transparent and non-evaporating liquid material to form an intimately conforming, long lasting air-free bridge between the integrated lens structure 66 and the light entrance 22. Additionally, the index of refraction of the anti-reflection layer 74, n_{AR}, should be selected to be essentially:

n_{AR}=SQRT(n_{L}×n_{E})

where n_{L} and n_{E} are, respectively, the index of refraction of the integrated lens structure 66 and the light entrance 22 and SQRT is a square root function.

FIG. 4C illustrates the placement of a liquid anti-reflection layer 78 between the light emitting element 40a and the integrated lens structure 66 to minimize an otherwise present light power loss due to Fresnel reflection at the interface between the light emitting element 40a and the integrated lens structure 66. The liquid anti-reflection layer 78 should be made of a transparent and non-evaporating material to form an intimately conforming, long lasting air-free bridge between the light emitting element 40a and the integrated lens structure 66. Additionally, the index of refraction of the liquid anti-reflection layer 78, n_{AR}, should be selected to be essentially:

n_{AR}=SQRT(n_{LED}×n_{L})

where n_{LED} and n_{L} are, respectively, the index of refraction of the light emitting element 40a and the integrated lens structure 66 and SQRT is a square root function.

Throughout the description and drawings, numerous exemplary embodiments were given with reference to specific configurations. It will be appreciated by those of ordinary skill in the art that the present invention can be embodied in numerous other specific forms and those of ordinary skill in the art would be able to practice such other embodiments without undue experimentation. For example, in FIG. 2A at least two of the light emitting elements 40a, 40b and 40c can be selected to emit the same light emission wavelength range and can also be simultaneously energized to increase the amount of light power exiting the light exit surfaces 28 at the same light emission wavelength range for applications requiring higher illumination power. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

What is claimed is:

1. A high optical efficiency illumination device comprising:
a light guide having a longitudinal axis, a transverse axis and a light entrance located at a first end of the longitudinal axis, the light guide further having a plurality of light reflective surfaces and opposing light exit surfaces located along the longitudinal axis for converting lights entering the light entrance into lights exiting through the light exit surfaces;
an illumination means, comprising a plurality of light emitting elements of various light emission wavelength ranges and arranged near the first end of the longitudinal axis, for emitting light beams into the light guide through the light entrance;
a mounting means, interposed between the illumination means and the light entrance, for locating and affixing the illumination means to the light entrance; and,
for each of at least one of the light emitting elements, the mounting means further comprises a corresponding integrated lens structure for collecting and collimating the light emission emanated from said each light emitting element into the light entrance
whereby maximize the optical efficiency of the illumination device defined, for each light emitting element, as the amount of light power exiting the light exit surfaces divided by the amount of light power emanated from said each light emitting element.

2. The illumination device of claim 1 wherein at least two of said plurality of light emitting elements are of the same pre-determined light emission wavelength range and are simultaneously energized whereby increase the amount of light power exiting the light exit surfaces at the pre-determined light emission wavelength range for applications requiring higher illumination power.

3. The illumination device of claim 1 wherein said corresponding integrated lens structure is sized and shaped to further collect and collimate the light emission emanated from said each light emitting element into a direction substantially parallel to the longitudinal axis.

4. The illumination device of claim 1 wherein said integrated lens structure is placed in intimate contact with the light entrance and the index of refraction of said integrated lens structure is selected to be essentially the same as that of the light entrance whereby further minimize an otherwise present light power loss due to Fresnel reflection at the interface between said integrated lens structure and the light entrance.

5. The illumination device of claim 1 further comprises an anti-reflection layer placed between said integrated lens structure and the light entrance to further minimize an otherwise present light power loss due to Fresnel reflection at the interface between said integrated lens structure and the light entrance.

6. The illumination device of claim 5 wherein said anti-reflection layer is made of a transparent and non-evaporating liquid material to form an intimately conforming, air-free bridge between said integrated lens structure and the light entrance.

7. The illumination device of claim 5 wherein the index of refraction of said anti-reflection layer, n_{AR}, is selected to be essentially:
n_{AR}=SQRT(n_{L}×n_{E})
where n_{L} and n_{E} are, respectively, the index of refraction of the integrated lens structure and the light entrance.

8. The illumination device of claim 1 wherein said integrated lens structure is placed in intimate contact with said each light emitting element and the index of refraction of said integrated lens structure is selected to be essentially the same as that of said each light emitting element whereby further minimize an otherwise present light power loss due to Fresnel reflection at the interface between said each light emitting element and said integrated lens structure.

9. The illumination device of claim 1 further comprises an anti-reflection layer placed between said each light emitting element and said integrated lens structure to further minimize an otherwise present light power loss due to Fresnel reflection at the interface between said each light emitting element and said integrated lens structure.

10. The illumination device of claim 9 wherein said anti-reflection layer is made of a transparent and non-evaporating liquid material to form an intimately conforming, air-free bridge between said each light emitting element and said integrated lens structure.

11. The illumination device of claim 9 wherein the index of refraction of said anti-reflection layer, n_{AR}, is selected to be essentially:
n_{AR}=SQRT(n_{LED}×n_{L})
where n_{LED} and n_{L} are, respectively, the index of refraction of said each light emitting element and said integrated lens structure.
